(19) United States
(12) Patent Application Publication
(10) Pub. No.: US 2015/0018041 A1
(43) Pub. Date: Jan. 15, 2015

(54) DISPLAY DEVICE INCLUDING A DISPLAY AND A HARDWARE POWER BUTTON

(71) Applicants: YOTA Devices IPR Ltd., Tortola (VG); YOTA Devices Ltd., Larnaca (CY)

(72) Inventors: Dmitry Gorilovsky, Nurnbert (DE); Dennis Sverdlov, St. Petersburg (RU)

(21) Appl. No.: 14/500,831

(22) Filed: Sep. 29, 2014

Related U.S. Application Data
(63) Continuation of application No. PCT/EP2013/056698, filed on Mar. 28, 2013.

(30) Foreign Application Priority Data
Mar. 28, 2012 (GB) 1205426.8
Aug. 7, 2012 (GB) 1214120.6

(51) Int. Cl. H04B 1/38; H04M 1/02

(52) U.S. Cl. CPC H04B 1/3816; H04M 1/0202
USPC 455/558

(57) ABSTRACT

There is provided a display device including a display and a hardware power button, wherein the power button is operable to open from the device to receive a subscriber identity module (SIM) card, and wherein the power button is operable to close so as to store the SIM card in the device, wherein the device is operable to use the SIM card to define a SIM identity for the device.

### BACKGROUND OF THE INVENTION

1. Field of the Invention

The field of the invention relates to display devices including a display and a hardware power button, especially to display devices for receiving a subscriber identity module (SIM) card. The field of the invention further relates to methods and to computer program products associated with such devices.

2. Technical Background

Many portable devices include assemblies which can receive cards which enable or enhance device capabilities. For example, mobile phones include SIM cards, and digital cameras may include memory expansion cards such as SD cards.

However, such devices may be stolen, and the stolen device may be used by an illegitimate user after changing a card, because the card may contain information which prevents another user using the device legitimately. It would be desirable to have a way of preventing a stolen device from having its card replaced without first being subject to a power on and potentially to a password entry process, which could help to ensure that only a legitimate user of the device can change a card of the device, even though an illegitimate user could still make a drastic step such as partly dismantling the device to access the card. Making it very difficult to change a card illegitimately may be particularly important when the device is relatively expensive, such as a smartphone, such as one described in WO2012044201(A2), which is incorporated by reference, because expensive devices are attractive to thieves.

### DISCUSSION OF RELATED ART

Replacing the SIM card in an iPhone 4S is easy. All you need is a SIM card eject tool or a small paper clip. You can use a SIM card eject tool or a paperclip to eject the SIM card and its holder. This may require a significant amount of force. Then you can remove the SIM Card tray assembly from the iPhone. Then you can remove the SIM card from its recess in the SIM card tray.

### SUMMARY OF THE INVENTION

According to a first aspect of the invention, there is provided a display device including a display and a hardware power button, wherein the power button is operable to open from the device to receive a subscriber identity module (SIM) card, and wherein the power button is operable to close so as to store the SIM card in the device, wherein the device is operable to use the SIM card to define a SIM identity for the device. The device has an advantage in that combining the SIM card receiver and the power button saves space in the device.

The device has an advantage in that, when the device includes a computer, the SIM card may be ejected in normal use by successful operation of a password protected computer-controlled user interface of the device, with the result that a thief cannot easily change the SIM card because typically they will not know the password. A further advantage is that the amount of force exerted on the power button for card removal can be carefully controlled, in contrast to manual operation, which may result in irreparable damage to a power button, or to a device including the power button.

The device may be one wherein the display includes a touch screen.

The device may be one wherein the power button may be opened by operating a soft key in a user interface of the device.

The device may be one wherein upon operating the soft key, the power button opens at least 2 mm.

The device may be one wherein the device comprises front and back major faces, the front major face arranged to present a first display screen and the back major face arranged to present a second display screen different to the first display screen.

The device may be one wherein the second display screen is a bi-stable display screen.

The device may be one wherein the bi-stable display screen is an E-ink bi-stable display screen.

The device may be one wherein the bi-stable screen occupies greater than 70% of the area of the major face of the device on which it is located.

The device may be one wherein the device is portable.

The device may be one wherein the device is a mobile phone, a portable digital assistant, a laptop, a digital audio player (eg. ipod), or a tablet computer (eg. ipad).

The device may be one wherein the device includes a concave front face and a convex rear face.

The device may be one wherein the device includes a card receiver assembly including a Shape Memory Alloy component, wherein the assembly is operable to receive the SIM card, and wherein the Shape Memory Alloy (SMA) component is actuatable to release the SIM card from the assembly.

The device may be one wherein the Shape Memory Alloy component includes a wire.

The device may be one wherein the Shape Memory Alloy component includes a bundle of wires.

The device may be one wherein the Shape Memory Alloy component is actuatable by passing a current through it.

The device may be one wherein the actuation voltage applied to the component is reduced to achieve an increased number of actuations.

The device may be one wherein the Shape Memory Alloy component is actuatable using an energy of between 0.1 J and 4 J.

The device may be one wherein the Shape Memory Alloy component is actuatable using an energy of between 1 J and 4 J.

The device may be one wherein the assembly includes a hook operable using the Shape Memory Alloy component to hold the SIM card in place, and releasable using the Shape Memory Alloy component to release the SIM card from the assembly.

The device may be one wherein the Shape Memory Alloy is a two-way shape-memory.

The device may be one wherein the Shape Memory Alloy is copper-aluminium-nickel or nickel-titanium.

The device may be one comprising a computer.

The device may be one wherein the Shape Memory Alloy (SMA) component is actuatable by the computer.

The device may be one wherein the Shape Memory Alloy (SMA) component is actuatable by software running on the computer.

The device may be one including a user interface, wherein the Shape Memory Alloy (SMA) component is actuatable by a user interface instruction received by the software running on the computer.

The device may be one including a card receiver wherein the card receiver comprises a hinge door mechanism that prevents release of the card in response to a pressing of the power button, but allows contact to a standard power tact switch.

The device may be one wherein the SIM card is a mini-SIM, a micro-SIM, or a nano-SIM.

According to a second aspect of the invention, there is provided a method of releasing a SIM card from a display device comprising a user interface, a display, a computer, and a SIM card receiver assembly, wherein the assembly is operable to receive a SIM card, the method comprising the steps of:

(i) the computer receiving an instruction via the user interface to release the SIM card from the device, and
(ii) the computer actuating the SIM card receiver assembly to release the SIM card from the assembly.

The method may be one wherein the device is a device according to the first aspect of the invention.

According to a third aspect of the invention, there is provided a computer program product, the computer program product executable on a display device comprising a user interface, a display, a computer, and a SIM card receiver assembly, wherein the assembly is operable to receive a SIM card, the computer program product when running on the computer operable to perform the method steps of:

(i) receiving an instruction via the user interface to release the SIM card from the device, and
(ii) actuating the SIM card receiver assembly to release the card from the assembly.

The computer program product may be one wherein the device is a device according to the first aspect of the invention.

### BRIEF DESCRIPTION OF THE DRAWINGS

The above and other aspects of the invention will now be described, by way of example only, with reference to the following Figures, in which:

FIG. 1 shows a SIM card receiver assembly which includes a shape memory alloy wire 10.

FIG. 2 shows the SIM card receiver assembly of FIG. 1 from a different perspective.

FIG. 3 shows an example of a current-limiting schematic for controlling actuation of a shape memory alloy wire.

FIG. 4 shows a prior art Japan Aviation Electronics (JAE) connector.

FIG. 5 shows an auto SIM connector.

FIG. 6 shows a perspective view of a device including a software-controlled SIM door; the software-controlled SIM door is shown in a closed configuration.

FIG. 7 shows a perspective view of a device including a software-controlled SIM door; the software-controlled SIM door is shown in an open configuration.

FIG. 8 shows an example of an interrelated power button and SIM Door.

### DETAILED DESCRIPTION

### Power Button for SIM Card Receiver

There is provided a display device with a hardware power button, wherein the power button is operable to open from the device to receive a SIM card, and to close so as to store the SIM card in the device, wherein the device is operable to use the SIM card to define a SIM identity for the device. The device may include a touch screen. The power button may be opened by operating a soft key in a user interface of the device. Upon operating the soft key, the power button may open at least 2 mm.

The display device may comprise front and back major faces, the front major face arranged to present a first display screen and the back major face arranged to present a second display screen different to the first display screen.

The display device may be a bar form factor device.

The display device may be one in which the second display screen uses electrowetting technology.

The display device may be one in which the second display screen is a Grayscale panel.

The display device may be one in which the second display screen is a bi-stable display screen.

The display device may be one in which a device appearance can be changed by changing what is displayed on the bi-stable display screen.

The display device may be one in which the bi-stable display screen is a bi-stable active matrix and high-resolution display screen.

The display device may be one in which the bi-stable display screen is an E-ink bi-stable display screen.

The display device may be one in which the second display screen is Electronic Paper Display under glass.

The display device may be one in which the second display screen uses interferometric modulation technology.

The display device may be one in which the device appearance is context-related.

The display device may be one in which the context-related device appearance includes location-based advertising.

The display device may be one in which the context-related device appearance includes results of a location-based search.

The display device may be one in which the device appearance can be changed to give an appearance of a different phone case.

The display device may be one in which the device skin can be changed.

The display device may be one in which the device skin is one or more of: wallpaper, photos, movies, or user-customized content.

The display device may be one in which the back face appears to be part of a device case.

The display device may be one in which the second display screen has a low power consumption.

The display device may be one in which the first display screen and the second display screen have similar resolutions.

The display device may be one in which the second display screen provides approximately at least 1000 full screen updates using 300 mAh of charge, for a screen size of approximately 4 inches.

The display device may be one in which the second display screen is operable to update at a rate the order of twice per minute.

The display device may be one in which the second screen does not consume power or require power when in a bi-stable state.

The display device may be one in which the device displays an image in an off state or in a low power notification mode.

The display device may be one in which an application or service executing on the device is able to display a notification on the second screen.

The display device may be one in which any application or service executing on the device is able to display a notification on the second screen.

The display device may be one in which a time period for which a notification is displayed is not limited.

The display device may be one in which an application or service executing on the device is able to display a notification on the first screen.

The display device may be one in which any application or service executing on the device is able to display a notification on the first screen.

The display device may be one in which a message is provided on the first screen and on the second screen.

The display device may be one in which the second display screen output provides one or more of: Interactions, Control, Use cases, Personalization, Widgets, Privacy.

The display device may be one in which the second display screen output provides a social network screen.

The display device may be one in which the second display screen output provides social aggregator output or social network output.

The display device may be one in which the social aggregator output or social network output is a Facebook page.

The display device may be one in which the second display screen output provides a Google search page.

The display device may be one in which the second display screen output provides device location.

The display device may be one in which the second display screen output provides Notifications.

The display device may be one in which the second display screen output provides Operator Push output.

The display device may be one in which the second display screen output provides news provided by a news service.

The display device may be one in which the second display screen output provides social messages provided by a social messaging service.

The display device may be one in which the second display screen output provides social messages provided by a social networking service.

The display device may be one in which the second display screen output provides calendar information.

The display device may be one in which the second display screen is the only operational display screen of the device when the device operates in a low power notification mode.

The display device may be one in which the second display screen displays content updates of one or more categories when the device operates in a low power notification mode.

The display device may be one in which the categories include one or more of news, social messages, an emergency notification, financial news, earthquake, tsunami or weather.

The display device may be one in which the categories are preselected.

The display device may be one in which the categories are preselected by a user.

The display device may be one in which the categories are preselected by a network services provider.

The display device may be one in which the device is a slate device.

The display device may be one in which the device is a bar or candybar device.

The display device may be one in which the device is a slab-shaped form.

The display device may be one in which the first display screen is a liquid crystal display screen.

The display device may be one in which the first display screen is an active-matrix organic light-emitting diode display screen.

The display device may be one in which in an ON state, the front face is back-illuminated and can display an image or other content; in the ON state, the bi-stable display on the back face also can display an image or other content.

The display device may be one in which the device comprises a touch screen.

The display device may be one in which the first display screen is a touch screen.

The display device may be one in which the second display screen is a bi-stable display touch screen.

The display device may be one in which the second display screen is a bi-stable display screen and the device includes a second bi-stable screen.

The display device may be one in which the second display screen is a bi-stable display screen and the bi-stable screen occupies greater than 70% of the area of the major face of the device on which it is located.

The display device may be one in which the bi-stable screen occupies greater than 90% of the area of the major face of the device on which it is located.

The display device may be one in which the bi-stable screen occupies greater than 95% of the area of the major face of the device on which it is located.

The display device may be one in which the first screen occupies greater than 70% of the area of the major face of the device on which it is located.

The display device may be one in which the first screen occupies greater than 90% of the area of the major face of the device on which it is located.

The display device may be one in which the first screen occupies greater than 95% of the area of the major face of the device on which it is located.

The display device may be one in which the device is portable.

The display device may be one in which the device is a mobile phone, a portable digital assistant, a laptop, a digital audio player (eg. ipod), or a tablet computer (eg. ipad).

The display device may be one in which the device includes a virtual keyboard.

The display device may be one in which the device includes a concave front face and a convex rear face.

The display device may be one in which the magnitudes of the curvatures of the front face and the rear face are the same or similar.

The display device may be one in which the curvature of front and back is cylindrical.

The display device may be one in which the curvature of front and back is spherical.

The display device may be one in which the curvature of front and back is aspherical.

The display device may be one in which the device has a resting position with its front face down which is mechanically stable.

The display device may be one in which the device concave front curvature matches the path of a finger as the user's wrist rotates.

The display device may be one in which if the bar form factor display device is placed back down (ie convex face down), the bar form factor display device can spin.

The display device may be one in which if the bar form factor display device is placed in a leg pocket of a user's clothing with the concave face facing the leg, this provides better antenna reception than if the convex face faces the leg.

The display device may be one in which a curved front face is a vibrating distributed mode loudspeaker (DML) speaker.

The display device may be one in which a curved rear face is a vibrating distributed mode loudspeaker (DML) speaker.

The display device may be one in which during manufacturing the curved shape is laminated to glass.

### Combined SIM-Slot/Power Button (eg. Integrated Power Button and SIM Door)

There is provided a subscriber identity module (SIM) card receiver assembly in which SIM release is achieved by actuating using a Shape Memory Alloy (SMA) wire. For a description of shape memory alloys, see Appendix 1. Units may be built with a prototype subscriber identity module (SIM) connector for testing and evaluation. SIM cards are described in Appendix 2.

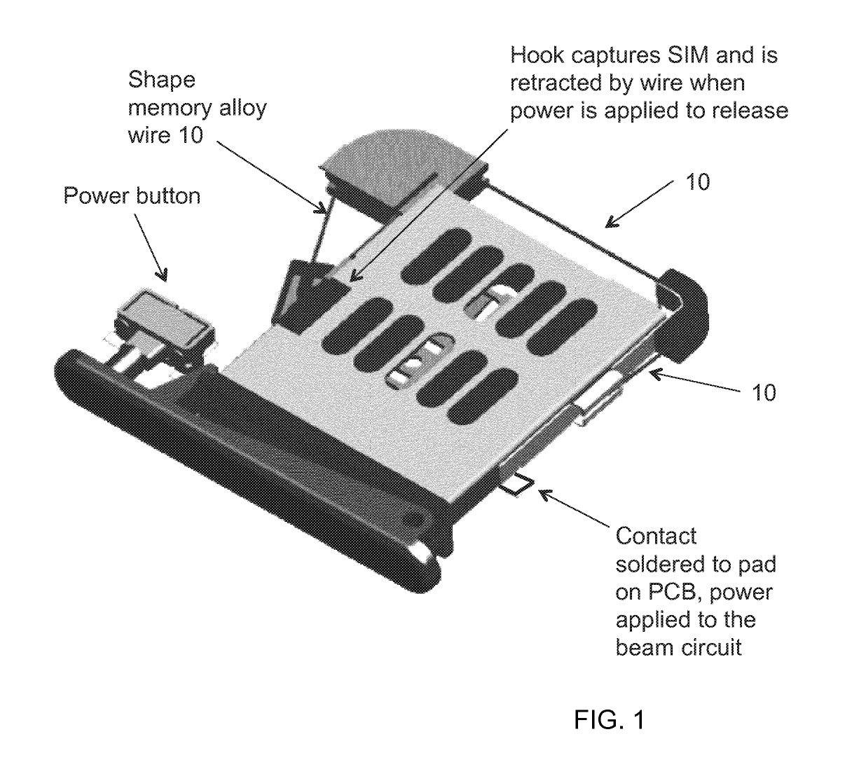

See FIGS. 1 to 5, and their related explanation, for examples of electrical schematic and requirements plus assumptions on component footprint. If for some reason the SMA wire or power fails, the only way to remove SIM may be by opening up the host device (eg. phone) completely.

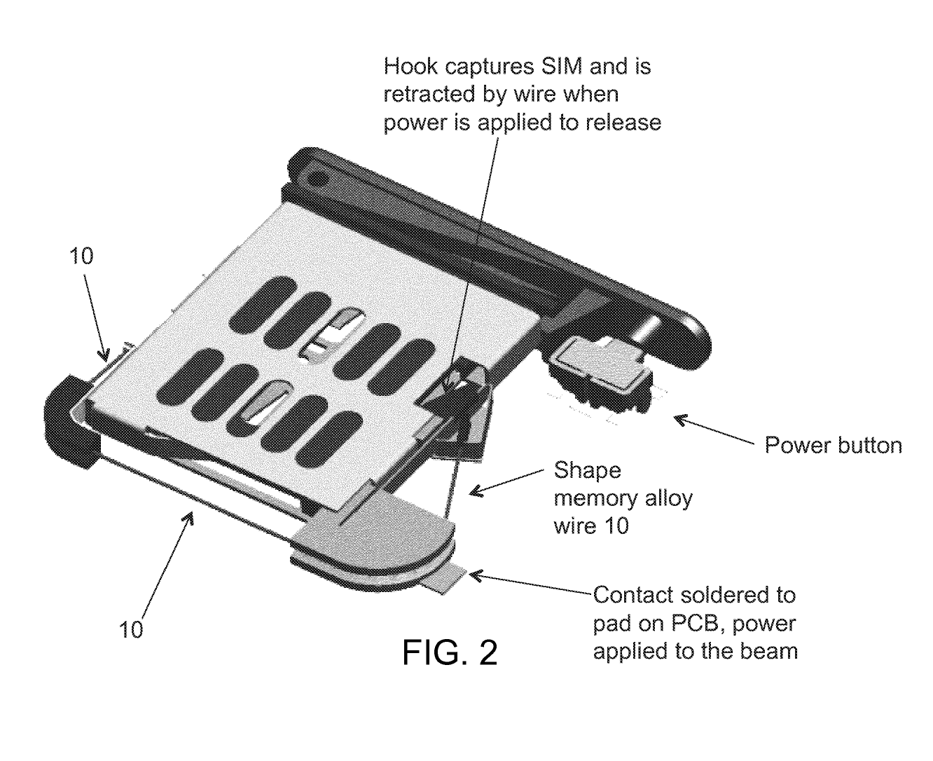

An example of a short hook concept, in which a Shape Memory Alloy (SMA) wire is used, is shown in FIGS. 1 and 2.

FIG. 1 shows a SIM card receiver assembly which includes a shape memory alloy wire 10. When the shape memory alloy wire 10 is actuated by passing a current through it, the wire retracts a hook; the hook serves to secure a SIM card in the SIM card receiver during normal operation of a host device (eg. a smart phone) which hosts the SIM card receiver assembly and the SIM card. Hence actuating the shape memory alloy wire 10 serves to release a SIM card from the SIM card receiver assembly. The SIM card receiver assembly of FIG. 1 includes a power button and a contact which is soldered to a pad on a printed circuit board (PCB) of the host device. Current to actuate the shape memory alloy wire flows through the contact pad. FIG. 2 shows the SIM card receiver assembly of FIG. 1 from a different perspective. In FIG. 2, a different contact is shown which is soldered to a pad on a printed circuit board (PCB) of the host device. Current to actuate the shape memory alloy wire flows through the contact pad.

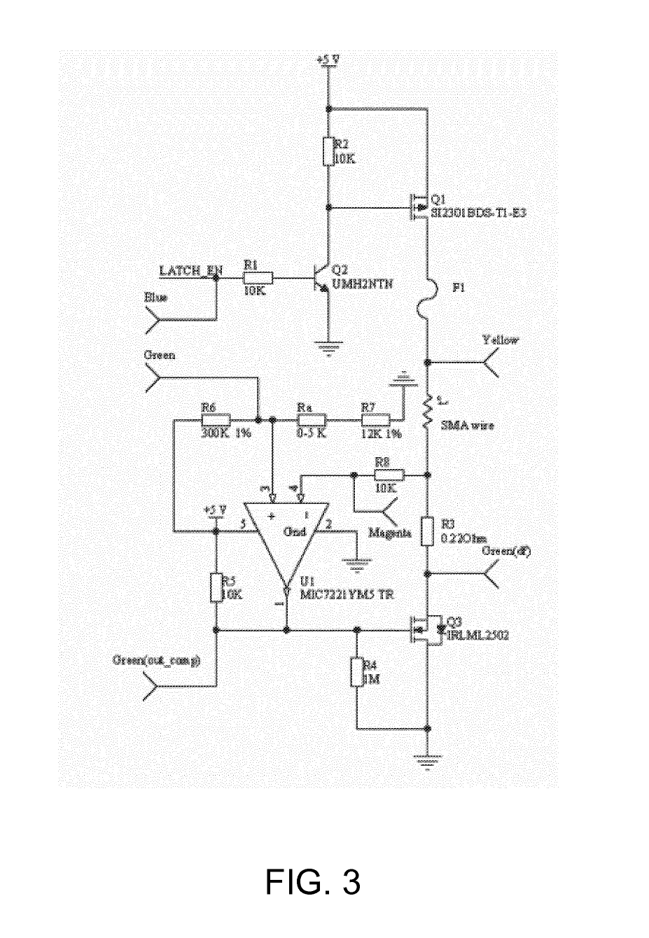

Example of sample current-limiting schematic for controlling actuation is shown in FIG. 3. In relation to FIG. 3:
Spec info re FIG. 3 is conservative for power requirements: there is good potential to reduce after some testing.
Power Profile: 750 mA with 1.0 s on time with regulated 5V supply (see suggested circuit in FIG. 3).
Energy consumption per cycle: <4.0 J.
Power consumption (operating): 3.75 W.
Operating temperature: +10° C.-+45° C. (50° F.-113° F.).
Survival temperature: −40° C.-+65° C. (−40° F.-+149° F.).
Cycle life: 5k minimum/10k expected.
By providing appropriate voltage to wire (according to Ohm's Law less voltage causes less current flowing through SMA wire), you can limit the current presented to the SMA device and thus reach a high number of actuations.

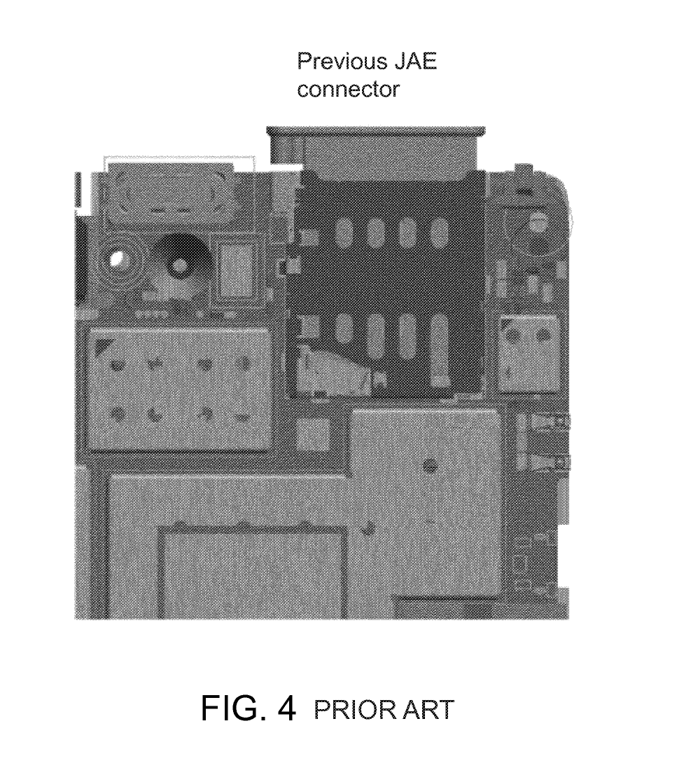

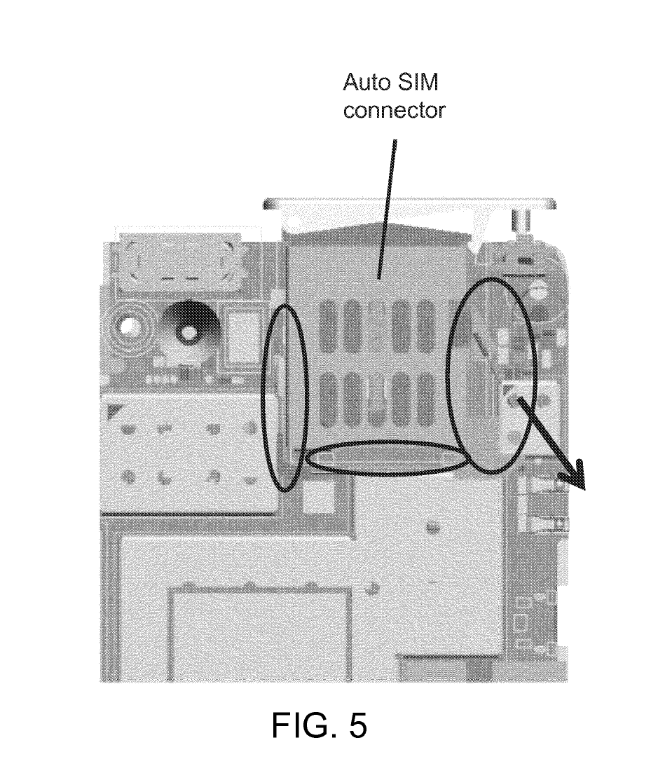

FIGS. 4 and 5 provide a connector comparison between a previous Japan Aviation Electronics (JAE) connector and the present auto SIM connector. In FIG. 5, the ellipses enclose sections of shape memory alloy wire. In FIG. 5, the black arrow denotes the direction of retraction of the shape memory alloy wire, which causes the hook holding a SIM card in place to move to release the SIM card.

### Software Controlled SIM Door

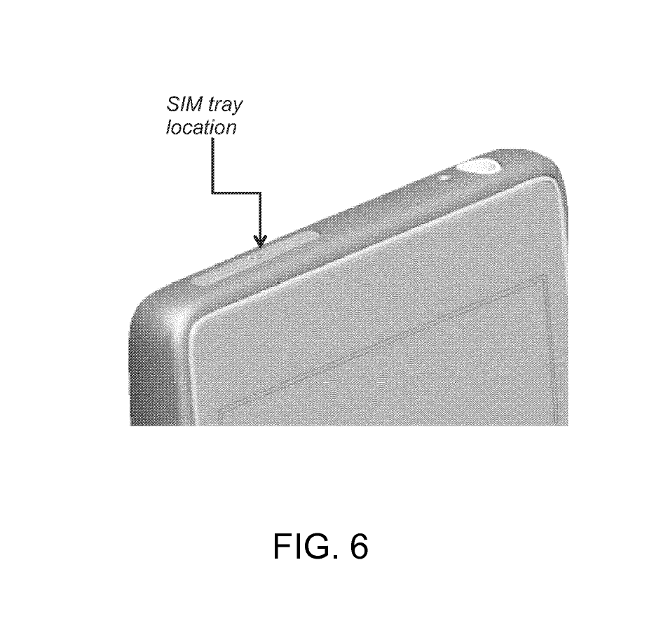

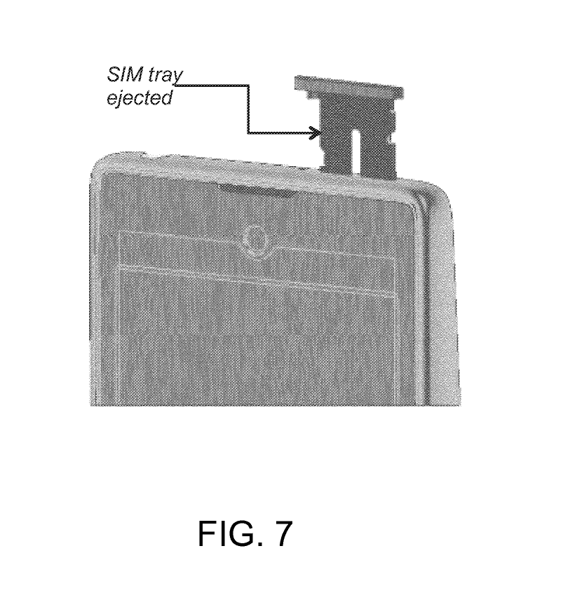

See FIGS. 6 and 7, for example.

The design incorporates a release mechanism, that has been engineered to allow the SIM tray to release from the product through a software user interface (UI) command. The SIM card consists of a SIM tray and the SIM tray takes a standard Micro SIM card. The design is miniaturized to minimize the SIM tray's design footprint. The electrical components within the design have been rationalized and minimized to create effective part bill of materials (BOM) cost. The SIM tray provides a solution to mobile phones that presently require internal battery packs. The SIM tray is designed such that it can be customized for other products. Examples include tablet computers and smart phones.

### Interrelated Power Button and SIM Door

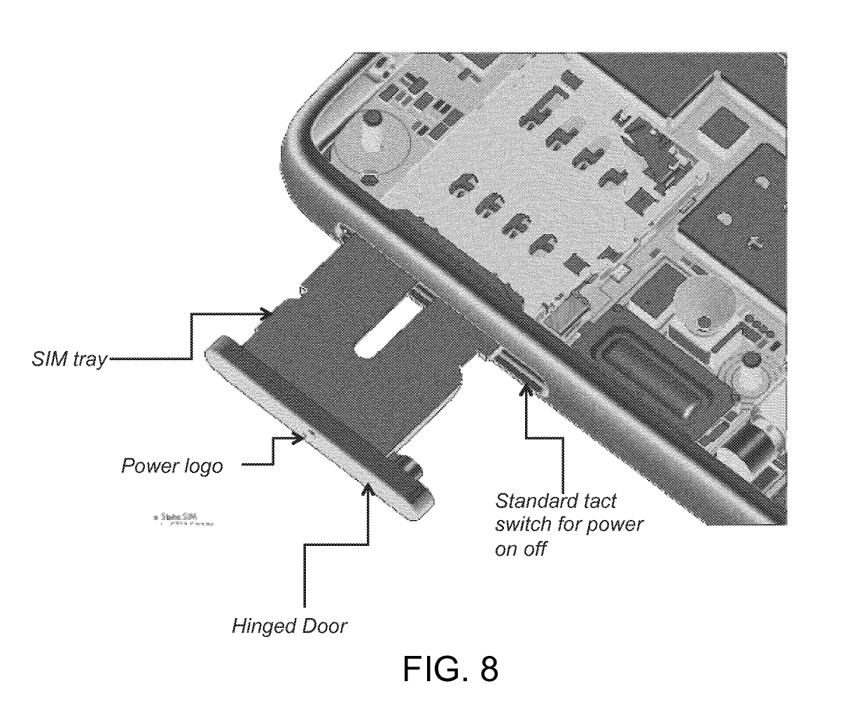

FIG. 8 shows an example of an interrelated power button and SIM Door. In the Figure, a SIM tray, a power logo, a hinged door and a standard tact switch for power on or off are shown. FIG. 8 shows the SIM tray in an open configuration.

The design incorporates a combination power button and SIM tray. The SIM tray has been engineered to contain a hinge door mechanism that prevents movement on the SIM door but allowing contact to a standard power tact switch. The design is miniaturized to minimize board area.

### Other Cards

Other cards may be received or ejected from a card receiver assembly which includes a shape memory alloy wire which is actuatable for ejecting the card. For example secure digital (SD) cards may be received or ejected from a SD card receiver assembly. Details of SD cards are given in Appendix 3.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### APPENDIX 1

### Shape Memory Alloys

A shape-memory alloy (SMA) is an alloy that “remembers” its original, cold-forged shape: returning the pre-deformed shape by heating.

The two main types of shape-memory alloys are the copper-aluminium-nickel, and nickel-titanium (NiTi) alloys but SMAs can also be created by alloying zinc, copper, gold and iron. NiTi alloys are generally more expensive and change from austenite to martensite upon cooling. Repeated use of the shape-memory effect may lead to a shift of the characteristic transformation temperatures (this effect is known as functional fatigue, as it is closely related with a change of microstructural and functional properties of the material).

### One-Way Memory Effect

When a shape-memory alloy is in its cold state, the metal can be bent or stretched and will hold those shapes until heated above the transition temperature. Upon heating, the shape changes to its original. When the metal cools again it will remain in the hot shape, until deformed again.

With the one-way effect, cooling from high temperatures does not cause a macroscopic shape change. A deformation is necessary to create the low-temperature shape.

### Two-Way Memory Effect

The two-way shape-memory effect is the effect that the material remembers two different shapes: one at low temperatures, and one at the high-temperature shape. A material that shows a shape-memory effect during both heating and cooling is called two-way shape memory. This can also be obtained without the application of an external force (intrinsic two-way effect). The reason the material behaves so differently in these situations lies in training. Training implies that a shape memory can “learn” to behave in a certain way. Under normal circumstances, a shape-memory alloy “remembers” its high-temperature shape, but upon heating to recover the high-temperature shape, immediately “forgets” the low-temperature shape. However, it can be “trained” to “remember” to leave some reminders of the deformed low-temperature condition in the high-temperature phases. There are several ways of doing this. A shaped, trained object heated beyond a certain point will lose the two-way memory effect, this is known as “amnesia”.

### Practical Limitations

SMA have many advantages over traditional actuators, but do suffer from a series of limitations that may impede practical application.

### Response Time and Response Symmetry

SMA actuators are typically actuated electrically, where an electric current results in Joule heating. Deactivation typically occurs by free convective heat transfer to the ambient environment. Consequently, SMA actuation is typically asymmetric, with a relatively fast actuation time and a slow deactuation time. A number of methods have been proposed to reduce SMA deactivation time, including forced convection, and lagging the SMA with a conductive material in order to manipulate the heat transfer rate.

Novel methods to enhance the feasibility of SMA actuators include the use of a conductive “lagging”. This method uses a thermal paste to rapidly transfer heat from the SMA by conduction. This heat is then more readily transferred to the environment by convection as the outer radii (and heat transfer area) is significantly greater than for the bare wire. This method results in a significant reduction in deactivation time and a symmetric activation profile. As a consequence of the increased heat transfer rate, the required current to achieve a given actuation force is increased.

### Fatigue and Functional Fatigue

SMA is subject to fatigue; a failure mode by which cyclic loading results in the initiation and propagation of a crack that eventually results in catastrophic loss of function by fracture. In addition to this failure mode, which is not exclusively observed in smart materials, SMA are also subject to Functional Fatigue, whereby the SMA does not fail structurally, but, due to a combination of applied stress, and/or temperature, loses (to some degree) its ability to undergo a reversible phase transformation.

### Unintended Actuation

SMA actuators are typically actuated electrically by Joule heating. If the SMA is used in an environment where the ambient temperature is uncontrolled, unintentional actuation by ambient heating may occur.

### Materials

Alloys of elements having the memory effect at different temperatures and at different percentages of its solid solution content are:
Ag—Cd 44/49 at. % Cd
Au—Cd 46.5/50 at. % Cd
Cu—Al—Ni 14/14.5 wt. % Al and 3/4.5 wt. % Ni
Cu—Sn approx. 15 at. % Sn
Cu—Zn 38.5/41.5 wt. % Zn
Cu—Zn—X (X=Si, Al, Sn)
Fe—Pt approx. 25 at. % Pt
Mn—Cu 5/35 at. % Cu
Fe—Mn—Si
Pt alloys
Co—Ni—Al
Co—Ni—Ga
Ni—Fe—Ga
Ti—Pd in various concentrations
Ni—Ti (˜55% Ni)
Ni—Ti—Nb
Ni—Mn—Ga

### APPENDIX 2

### SIM Cards

A subscriber identity module or subscriber identification module (SIM) is an integrated circuit that securely stores the International Mobile Subscriber Identity (IMSI) and the related key used to identify and authenticate subscribers on mobile telephony devices (such as mobile phones and computers).

A SIM is embedded into a removable SIM card, which can be transferred between different mobile devices. SIM cards were first made the same size as a credit card (85.60 mm×53.98 mm×0.76 mm) The development of physically-smaller mobile devices prompted the development of a smaller SIM card, the mini-SIM card. Mini-SIM cards have the same thickness as full-size cards, but their length and width are reduced to 25 mm×15 mm.

A SIM card contains its unique serial number (ICCID), international mobile subscriber identity (IMSI), security authentication and ciphering information, temporary information related to the local network, a list of the services the user has access to and two passwords: a personal identification number (PIN) for ordinary use and a personal unblocking code (PUK) for PIN unlocking.

SIM cards have been made smaller over the years; functionality is independent of format. Full-size SIMs were followed by mini-SIMs, micro-SIMs, and nano-SIMs. SIMs are also made to be embedded in devices.

The first to appear was the full-size or 1FF (1st form factor), the size of a credit card (85.60 mm×53.98 mm×0.76 mm) It was followed by a version of the same thickness but 25 mm long by 15 mm wide, with one of its corners truncated (chamfered) to prevent misinsertion. It is known as a mini-SIM or 2FF (2nd form factor). The next version was the micro-SIM or 3FF (3rd form factor), with dimensions of 15 mm×12 mm.

The mini-SIM card has the same contact arrangement as the full-size SIM card and is normally supplied within a full-size card carrier, attached by a number of linking pieces. This arrangement (defined in ISO/IEC 7810 as ID-1/000) allows such a card to be used in a device requiring a full-size card, or in a device requiring a mini-SIM card after breaking the linking pieces.

The later 3FF card or micro-SIM cards have the same thickness and contact arrangements, but the length and width are further reduced as above.

In early 2012, the nano-SIM or 4FF (4th form factor) was introduced, which measures 12.3×8.8×0.67 mm and reduces the previous format to the contact area while maintaining the existing contact arrangements. A small rim of isolating material is left around the contact area to avoid short circuits with the socket. The 0.7 mm thickness of the nano-SIM is about 15 percent less than its predecessor. 4FF can be put into adapters for use with devices taking 2FF or 3FF SIMs.

### APPENDIX 3

### SD Cards

Secure Digital or (SD) is a non-volatile memory card format for use in portable devices, such as mobile phones, digital cameras, GPS navigation devices, and tablet computers.

The Secure Digital standard is maintained by the SD Card Association (SDA). SD technologies have been implemented in more than 400 brands across dozens of product categories and more than 8,000 models.

The Secure Digital format includes four card families available in three different form factors. The four families are the original Standard-Capacity (SDSC), the High-Capacity (SDHC), the eXtended-Capacity (SDXC), and the SDIO, which combines input/output functions with data storage. The three form factors are the original size, the “mini” size, and the “micro” size (see illustration). There are many combinations of form factors and device families.

### Types of Cards

The SDA extended the SD specification in various ways:
It defined electrically identical cards in smaller sizes: miniSD and microSD (originally named TransFlash or TF). Smaller cards are usable in larger slots through use of a passive adapter. By comparison, Reduced Size MultiMediaCards (RS-MMCs) are simply shorter MMCs and can be used in MMC slots by use of a physical extender.
It defined higher-capacity cards, some with faster speeds and added capabilities: SDHC (Secure Digital High Capacity) and SDXC (Secure Digital eXtended Capacity). These cards redefine the interface so that they cannot be used in older host devices.
It defined an SDIO card family that provides input-output functions and may also provide memory functions. These cards are only fully functional in host devices designed to support their input-output functions.

### Physical Size

Size comparison of families: SD, miniSD, microSD

The SD card specification defines three physical sizes. The SD and SDHC families are available in all three sizes, but the SDXC family is not available in the mini size, and the SDIO family is not available in the micro size.

### Standard Size

SD (SDSC), SDHC, SDXC, SDIO
32.0×24.0×2.1 mm (1.26×0.94×0.083 in)
32.0×24.0×1.4 mm (1.26×0.94×0.055 in) (as thin as MMC) for Thin SD (rare)

### Mini Size

miniSD, miniSDHC, miniSDIO
21.5×20.0×1.4 mm (0.85×0.79×0.055 in)

### Micro Size

The microSD form factor is the smallest memory card format currently available.
microSD, microSDHC, microSDXC
15.0×11.0×1.0 mm (0.59×0.43×0.039 in)

### SDHC

The Secure Digital High Capacity (SDHC) format, defined in Version 2.0 of the SD specification, supports cards with capacities up to 32 GB.

SDHC cards are physically and electrically identical to standard-capacity SD cards (SDSC). The major compatibility issues between SDHC and SDSC cards are the redefinition of the Card-Specific Data (CSD) register in Version 2.0 (see below), and the fact that SDHC cards are shipped preformatted with the FAT32 file system.

Host devices that accept SDHC cards are required to accept SDSC cards. However, host devices designed for SDSC do not recognize SDHC or SDXC memory cards, although some devices can do so through a firmware upgrade. Older operating systems require patches to support SDHC. For instance, Microsoft Windows XP before SP3 requires a patch to support access to SDHC cards. Windows Vista SP1 also requires a later service pack.

### SDXC

The Secure Digital eXtended Capacity (SDXC) format supports cards up to 2 TB (2048 GB), compared to a limit of 32 GB for SDHC cards in the SD 2.0 specification.

### CONCEPTS

This disclosure includes multiple concepts, including those described as concepts ‘A-H’ below. The following may be helpful in defining these concepts. Aspects of the concepts may be combined.

### A. Card Receiver Assembly

There is provided a card receiver assembly including a Shape Memory Alloy component, wherein the assembly is operable to receive a card, and wherein the Shape Memory Alloy (SMA) component is actuatable to release the card from the assembly. The card receiver assembly has an advantage in that, when housed in a device including a computer, the card may be ejected in normal use by successful operation of a computer-controlled user interface of the device. A further advantage is that the amount of force exerted on the assembly for card removal can be carefully controlled, in contrast to manual operation, which may result in irreparable damage to a card receiver assembly, or to a device including the card receiver assembly.

The above may include additionally any of the following, alone or in combination:
the Shape Memory Alloy component includes a wire.
the Shape Memory Alloy component includes a bundle of wires.
the Shape Memory Alloy component is actuatable by passing a current through it.
the actuation voltage applied to the component is reduced to achieve an increased number of actuations.
the Shape Memory Alloy component is actuatable using an energy of between 0.1 J and 4 J.
the Shape Memory Alloy component is actuatable using an energy of between 1 J and 4 J.
the assembly includes a hook operable using the Shape Memory Alloy component to hold the card in place, and releasable using the Shape Memory Alloy component to release the card from the assembly.
the card is a SIM card.
the SIM card is a mini-SIM, a micro-SIM, or a nano-SIM.
the card is a SD card.
the SD card is a SDHC, a SDXC, a SDIO, a mini size card or a micro size card.
the Shape Memory Alloy is a two-way shape-memory.
the Shape Memory Alloy is copper-aluminium-nickel or nickel-titanium.

### B. Device Including a Card Receiver Assembly

There is provided device including a card receiver assembly as described in concept A.

The above may include additionally any of the following, alone or in combination:
Device comprises a display, a computer and the card receiver assembly.
the Shape Memory Alloy (SMA) component is actuatable by the computer.
the Shape Memory Alloy (SMA) component is actuatable by software running on the computer.
Device including a user interface, wherein the Shape Memory Alloy (SMA) component is actuatable by a user interface instruction received by the software running on the computer.
the card receiver assembly forms part of a hardware power button of the device, wherein the power button is operable to open from the device to receive a card, and to close so as to store the card in the device.
the card receiver comprises a hinge door mechanism that prevents release of the card in response to a pressing of the power button, but allows contact to a standard power tact switch.
the device is operable to use a card stored in the card receiver assembly to define an identity for the device.
the device is a bar form factor device comprising front and back major faces, the front major face arranged to present a first display screen and the back major face arranged to present a second display screen different to the first display screen.

### C. Method of Releasing a Card from a Display Device

There is provided a method of releasing a card from a display device comprising a user interface, a display, a computer, and a card receiver assembly including a Shape Memory Alloy component, wherein the assembly is operable to receive a card, the method comprising the steps of:

(i) the computer receiving an instruction via the user interface to release the card from the device, and
(ii) the computer actuating the Shape Memory Alloy (SMA) component to release the card from the assembly.

The method may be performed on a device according to concept B.

There is further provided a computer program product, the computer program product executable on a display device comprising a user interface, a display, a computer, and a card receiver assembly including a Shape Memory Alloy component, wherein the assembly is operable to receive a card, the computer program product when running on the computer operable to perform the method steps of:

(i) receiving an instruction via the user interface to release the card from the device, and
(ii) actuating the Shape Memory Alloy (SMA) component to release the card from the assembly.

The computer program product may run on a device according to concept B.

### D. Power Button Assembly Operable to Receive a Card

There is provided a power button assembly, wherein the power button assembly comprises a card receiver assembly operable to receive a card.

The above may include additionally any of the following, alone or in combination:
Card receiver assembly includes a Shape Memory Alloy component, wherein the Shape Memory Alloy (SMA) component is actuatable to release the card from the assembly.
the Shape Memory Alloy component includes a wire.
the Shape Memory Alloy component includes a bundle of wires.
the Shape Memory Alloy component is actuatable by passing a current through it.
the actuation voltage applied to the component is reduced to achieve an increased number of actuations.
the Shape Memory Alloy component is actuatable using an energy of between 0.1 J and 4 J.
the Shape Memory Alloy component is actuatable using an energy of between 1 J and 4 J.
the assembly includes a hook operable using the Shape Memory Alloy component to hold the card in place, and releasable using the Shape Memory Alloy component to release the card from the assembly.
the card is a SIM card.
the SIM card is a mini-SIM, a micro-SIM, or a nano-SIM.
the card is a SD card.
the SD card is a SDHC, a SDXC, a SDIO, a mini size card or a micro size card.
the Shape Memory Alloy is a two-way shape-memory.
the Shape Memory Alloy is copper-aluminium-nickel or nickel-titanium.

### E. Device Including a Power Button Assembly Operable to Receive a Card

There is provided a device including a power button assembly according to concept D.

The above may include additionally any of the following, alone or in combination:
Device comprises a display and a computer.
the Shape Memory Alloy (SMA) component is actuatable by the computer.
the Shape Memory Alloy (SMA) component is actuatable by software running on the computer.
Device includes a user interface, wherein the Shape Memory Alloy (SMA) component is actuatable by a user interface instruction received by the software running on the computer.
the power button assembly forms part of a hardware power button of the device, wherein the power button is operable to open from the device to receive a card, and to close so as to store the card in the device.
the card receiver comprises a hinge door mechanism that prevents release of the card in response to a pressing of the power button, but allows contact to a standard power tact switch.
the device is operable to use a card stored in the card receiver assembly to define an identity for the device.
the device is a bar form factor device comprising front and back major faces, the front major face arranged to present a first display screen and the back major face arranged to present a second display screen different to the first display screen.

### F. Method of Releasing a Card from Power Button of a Display Device

There is provided a method of releasing a card from a power button assembly of a display device, the device comprising a user interface, a display, a computer, and a power button assembly including a card receiver assembly, the card receiver assembly including a Shape Memory Alloy component, wherein the card receiver assembly is operable to receive a card, the method comprising the steps of:

(i) the computer receiving an instruction via the user interface to release the card from the device, and
(ii) the computer actuating the Shape Memory Alloy (SMA) component to release the card from the power button assembly.

The method may be performed on a device according to concept E.

There is further provided a computer program product, the computer program product executable on a display device comprising a user interface, a display, a computer, and a power button assembly including a card receiver assembly, the card receiver assembly including a Shape Memory Alloy component, wherein the card receiver assembly is operable to receive a card, the computer program product when running on the computer operable to perform the method steps of:

(i) receiving an instruction via the user interface to release the card from the device, and
(ii) actuating the Shape Memory Alloy (SMA) component to release the card from the power button assembly.

The computer program product may run on a device according to concept E.

### G. Method of Releasing a Card from a Handheld Mobile Phone Display Device

There is provided a method of releasing a card from a handheld mobile phone display device comprising a user interface, a display, a computer, and a card receiver assembly, wherein the assembly is operable to receive a card, the method comprising the steps of:

(i) the computer receiving an instruction via the user interface to release the card from the device, and
(ii) the computer actuating a component to release the card from the assembly.

The above may include additionally any of the following, alone or in combination:
the card is a SIM card.
the SIM card is a mini-SIM, a micro-SIM, or a nano-SIM.
the card is a SD card.
the SD card is a SDHC, a SDXC, a SDIO, a mini size card or a micro size card.

There is further provided a computer program product, the computer program product executable on a handheld mobile phone display device comprising a user interface, a display, a computer, and a card receiver assembly, wherein the assembly is operable to receive a card, the computer program product when running on the computer operable to perform the method steps of:

(i) receiving an instruction via the user interface to release the card from the device, and
(ii) actuating the a component to release the card from the assembly.

### H. Display Device Including a Display and a Hardware Power Button Operable to Receive a Subscriber Identity Module (SIM) Card

There is provided a display device including a display and a hardware power button, wherein the power button is operable to open from the device to receive a subscriber identity module (SIM) card, and wherein the power button is operable to close so as to store the SIM card in the device, wherein the device is operable to use the SIM card to define a SIM identity for the device.

The above may include additionally any of the following, alone or in combination:
the display includes a touch screen.
the power button may be opened by operating a soft key in a user interface of the device.
upon operating the soft key, the power button opens at least 2 mm.
the device comprises front and back major faces, the front major face arranged to present a first display screen and the back major face arranged to present a second display screen different to the first display screen.
the second display screen is a bi-stable display screen.
the bi-stable display screen is an E-ink bi-stable display screen.
the bi-stable screen occupies greater than 70% of the area of the major face of the device on which it is located.
the device is portable.
the device is a mobile phone, a portable digital assistant, a laptop, a digital audio player (eg. ipod), or a tablet computer (eg. ipad).
the device includes a concave front face and a convex rear face.
The device is a smartphone.

There is further provided a method of releasing a SIM card from a display device comprising a user interface, a display, a computer, and a SIM card receiver assembly, wherein the assembly is operable to receive a SIM card, the method comprising the steps of:

(i) the computer receiving an instruction via the user interface to release the SIM card from the device, and
(ii) the computer actuating the SIM card receiver assembly to release the SIM card from the assembly.

The method may be performed on a device according to any of the above statements.

There is further provided a computer program product, the computer program product executable on a display device comprising a user interface, a display, a computer, and a SIM card receiver assembly, wherein the assembly is operable to receive a SIM card, the computer program product when running on the computer operable to perform the method steps of:

(i) receiving an instruction via the user interface to release the SIM card from the device, and
(ii) actuating the SIM card receiver assembly to release the SIM card from the assembly.

The computer program product may be run on a device according to any of the above statements.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. Display device including a display and a hardware power button, wherein the power button is operable to open from the device to receive a subscriber identity module (SIM) card, and wherein the power button is operable to close so as to store the SIM card in the device, wherein the device is operable to use the SIM card to define a SIM identity for the device.

2. Device of claim 1 wherein the display includes a touch screen.

3. Device of claim 1, wherein the power button is openable by operating a soft key in a user interface of the device.

4. Device of claim 1, wherein upon operating the soft key, the power button opens at least 2 mm.

5. Device of claim 1, wherein the device comprises front and back major faces, the front major face arranged to present a first display screen and the back major face arranged to present a second display screen different to the first display screen.

6. Device of claim 5, wherein the second display screen is a bi-stable display screen.

7. Device of claim 6, wherein the bi-stable display screen is an E-ink bi-stable display screen.

8. Device of claim 6, wherein the bi-stable screen occupies greater than 70% of the area of the major face of the device on which it is located.

9. Device of claim 1, wherein the device is portable.

10. Device of claim 1, wherein the device is a mobile phone, a portable digital assistant, a laptop, a digital audio player (eg. ipod), or a tablet computer (eg. ipad).

11. Device of claim 1, wherein the device includes a concave front face and a convex rear face.

12. Device of claim 1, wherein the device includes a card receiver assembly including a Shape Memory Alloy component, wherein the assembly is operable to receive the SIM card, and wherein the Shape Memory Alloy (SMA) component is actuatable to release the SIM card from the assembly.

13. Device of claim 12, wherein the Shape Memory Alloy component includes a wire.

14. Device of claim 12, wherein the Shape Memory Alloy component includes a bundle of wires.

15. Device of claim 12, wherein the Shape Memory Alloy component is actuatable by passing a current through it.

16. Device of claim 15, wherein the actuation voltage applied to the component is reduced to achieve an increased number of actuations.

17. Device of claim 12, wherein the Shape Memory Alloy component is actuatable using an energy of between 0.1 J and 4 J.

18. Device of claim 17, wherein the Shape Memory Alloy component is actuatable using an energy of between 1 J and 4 J.

19. Device of claim 8 wherein the assembly includes a hook operable using the Shape Memory Alloy component to hold the SIM card in place, and releasable using the Shape Memory Alloy component to release the SIM card from the assembly.

20. Device of claim 12, wherein the Shape Memory Alloy is a two-way shape-memory.

21. Device of claim 12, wherein the Shape Memory Alloy is copper-aluminium-nickel or nickel-titanium.

22. Device of claim 12 wherein the device comprises a computer.

23. Device of claim 22, wherein the Shape Memory Alloy (SMA) component is actuatable by the computer.

24. Device of claim 22, wherein the Shape Memory Alloy (SMA) component is actuatable by software running on the computer.

25. Device of claim 24 including a user interface, wherein the Shape Memory Alloy (SMA) component is actuatable by a user interface instruction received by the software running on the computer.

26. Device of claim 1, wherein the device includes a SIM card receiver comprising a hinge door mechanism that prevents release of the SIM card in response to a pressing of the power button, but allows contact to a standard power tact switch.

27. Device of claim 1, wherein the SIM card is a mini-SIM, a micro-SIM, or a nano-SIM.

28. Method of releasing a SIM card from a display device comprising a user interface, a display, a computer, and a SIM card receiver assembly, wherein the assembly is operable to receive a SIM card, the method comprising the steps of:
(i) the computer receiving an instruction via the user interface to release the SIM card from the device, and
(ii) the computer actuating the SIM card receiver assembly to release the card from the assembly.

29. Computer program product, the computer program product executable on a display device comprising a user interface, a display, a computer, and a SIM card receiver assembly, wherein the assembly is operable to receive a SIM card, the computer program product when running on the computer operable to perform the method steps of:
(i) receiving an instruction via the user interface to release the SIM card from the device, and
(ii) actuating the SIM card receiver assembly to release the card from the assembly.
